(19) United States
(12) Patent Application Publication
(10) Pub. No.: US 2006/0164431 A1
(43) Pub. Date: Jul. 27, 2006

(54) Apparatus and method for displaying graphic objects concurrently

(75) Inventors: Sung-ho Yoon, Seoul (KR); Bom-jun Kwon, Seoul (KR); Jang-seok Seo, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS, CO.,LTD.

(21) Appl. No.: 11/231,898

(22) Filed: Sep. 22, 2005

(30) Foreign Application Priority Data
Jan. 26, 2005 (JP) 10-2005-0007174

(51) Int. Cl. G09G 5/00

(52) U.S. Cl. 345/619

(57) ABSTRACT

An apparatus is provided for displaying all graphic objects after having captured a point in time when an event is transmitted to the last graphic object, when a double buffering method is used, to prevent a transition of a windows system generated by visually observable intervals occurring between events where graphic objects are displayed on a screen by an event handler. Similarly, a method is provided for concurrently displaying graphic objects, the method including checking whether an event to display a graphic object has been generated, storing the graphic object processed according to the event, checking the number of times the event, whose generation has been checked, and the graphic object have been processed, and displaying the stored graphic object as a result of the check.

### CROSS-REFERENCE TO RELATED APPLICATION

This application claims priority from Korean Patent Application No. 10-2005-0007174 filed on Jan. 26, 2005 in the Korean Intellectual Property Office, the disclosure of which is incorporated herein in its entirety by reference.

### BACKGROUND OF THE INVENTION

1. Field of the Invention

Apparatuses and methods consistent with the present invention relate to displaying graphic objects concurrently, and more particularly, to displaying all graphic objects after knowing a time that an event is transmitted to the last graphic object, when a double buffering method is used to prevent a visually observable transition in a system supporting a plurality of windows (hereinafter referred to as a “windows system”) because of intervals occurring between events, in a case where a plurality of graphic objects are displayed on a screen by an event handler.

2. Description of the Related Art

With the complexity and the number of functions of electronic home appliances increasing, windows systems may be used to efficiently output graphic objects on a screen of the electronic home appliances.

Since a variety of electronic home appliances, such as a digital television (TV), a refrigerator with a control panel, and a Home-Pad, provide users with visual services, the devices can be more conveniently used. Accordingly, the windows system, with its high graphic outputting performance, can be applied to electronic home appliances.

Generally, a window in a windows system communicates with an application by using an event, and the application can operate in the windows system as a handler for the event.

Contrary to procedural programs, windows programs are event-driven or message-driven.

FIG. 1 is a view showing a structure of a conventional windows application.

As shown therein, the windows application 10 (hereinafter referred to as an “application”) includes a message loop 12 and a windows procedure 13, which are processed by each program. Generally, the application 10 consists of at least one window (i.e., a main window). Also, when several windows are used in the application 10, a message generated from each window is transmitted to the windows procedure 13 through the message loop 12.

Once the application 10 is executed, a message queue 11 is allocated to the application. Next, when an event is generated in a window of the application 10, the windows system (i.e., the operating system) inputs the generated message (event) into the message queue 11 of the application 10. At this time, the application 10 that received the message sends it to the windows procedure 13 after having processed it in the message loop 12. This is accomplished by a proper processing routine predetermined in order to process the message in the windows procedure 13.

When a graphic object is displayed on a screen, an event is generated at each object, thereby allowing each object to be displayed on a screen through the windows procedure 13. Here, when a plurality of objects are displayed on a screen of a system with poor performance, intervals between displaying of the various objects may be visually perceptible because of intervals between the corresponding events being generated or the processing efficiency of the windows procedure. In order to prevent this problem, a double buffering method is used.

The double buffering method does not display graphic objects directly on a screen, rather it stores them in a buffer (memory) and then displays them on a screen.

However, since the order of outputting a main window and a lower level window is not clear when the windows are not output on a screen through a single thread, it is difficult to know the time when both windows were sent to the buffer.

Japanese Unexamined Patent Publication No. 10-011258 discloses a system of delaying transfer of focus from an existing window to a new window by maintaining the current focus until the new window is clicked, if a user is inputting characters in the existing window when he or she opens the new window.

### SUMMARY OF THE INVENTION

According to an aspect of the present invention, a plurality of graphic objects are displayed after capturing a point in time when an event is transferred to a last graphic object and processed thereby, when graphic objects are displayed on a screen through an event handler.

According to another aspect of the present invention, there is provided an apparatus for concurrently displaying a plurality of graphic objects, the apparatus comprising an event check unit which checks whether an event has been generated to display a graphic object; a buffer which stores the graphic object processed according to the event generated to display the graphic object; a determination unit which determines a value from a number of times the event has been generated according to the check unit and a number of times the graphic object has been processed; and a display unit which displays the graphic object stored in the buffer as a result of the value.

According to another aspect of the present invention, there is provided a method for concurrently displaying a plurality of graphic objects, the method comprising checking whether an event to display a graphic object has been generated, storing the graphic object processed according to the event, determining a value from a number of times the event has been generated and a number of times the graphic object has been processed, and displaying the graphic object as a result of the value.

### BRIEF DESCRIPTION OF THE DRAWINGS

The above aspects of the present invention will become more apparent by describing in detail exemplary embodiments thereof with reference to the attached drawings in which:

FIG. 1 is a view showing a structure of the conventional windows application;

FIG. 2 is a block diagram showing an apparatus displaying graphic objects concurrently, according to an exemplary embodiment of the present invention;

FIG. 3A is a flowchart showing an increase in counting events by checking events generated, according to an exemplary embodiment of the present invention;

FIG. 3B is a flowchart showing displaying graphic objects concurrently, according to an exemplary embodiment of the present invention.

FIG. 4 is a view showing displaying a plurality of windows by using one variable, according to an exemplary embodiment of the present invention;

FIG. 5 is a view showing displaying a plurality of windows by using a plurality of variables, according to an exemplary embodiment of the present invention; and

FIG. 6 is a block diagram showing a digital TV displaying thereon graphic objects concurrently, according to an exemplary embodiment of the present invention.

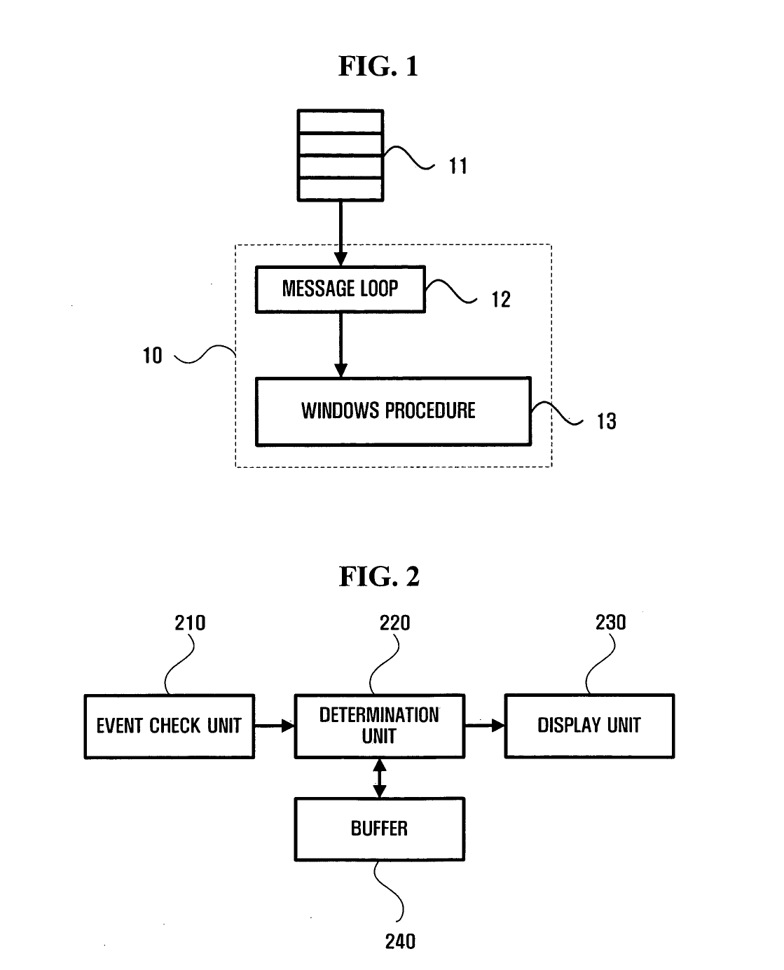

### DETAILED DESCRIPTION OF THE EXEMPLARY EMBODIMENTS OF THE PRESENT INVENTION

The present invention and methods of accomplishing the same may be understood more readily by reference to the following detailed description of the exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification and drawings.

Hereinafter, exemplary embodiments of the present invention will be described in more detail with reference to the accompanying drawings.

FIG. 2 is a block diagram showing an apparatus for displaying graphic objects concurrently, according to an exemplary embodiment of the present invention.

The apparatus for displaying graphic objects concurrently comprises an event check unit 210, a determination unit 220, a display unit 230, and a buffer 240.

The event check unit 210 checks whether an event has been generated to display a graphic object.

Here, the graphic object may refer to, for example, at least one of a window, a frame, a dialogue, a button, a check box, a radio box, a list, a scroll bar and a menu bar. Each graphic object is processed by an event generated through a thread.

Because each graphic object may belong to a different thread or process, the point in time when the event corresponding to the graphic object is processed is not clear.

A windows application generally consists of one or more windows, and has a message loop and a windows procedure. Also, one or more message queues are allocated to each windows application. One message queue is allocated to each message loop in most cases.

When an event to display a graphic object is generated in a window of the application, the windows operating system or a window manager inputs a message generated by a message queue of the application. The event check unit 210 checks the message queue to see whether the event to display the graphic object has been generated.

The application that received the message transfers the message transmitted from the windows operating system to the windows procedure after having processed the message in the message loop. A proper processing routine transfers the message to display the graphic object to the windows procedure in order to process the message.

The buffer 240 temporarily stores the graphic object processed by the windows procedure depending upon whether an event has been generated, as checked by the event check unit 210.

Here, storing an object does not just imply that data of the graphic object is stored in memory, it also implies that the graphic object is written in an allocated memory area to be actually output on a screen.

The determination unit 220 checks the number of times the event, whose generation has been checked by the event check unit 210, has been processed, and the number of times that the graphic object has been processed by the windows procedure.

Actually, the determination unit 220 does this checking by using a variable stored in another area of the memory. The determination unit 220 adds 1 to a value of the variable whenever the event check unit 210 checks the generation of an event, and subtracts 1 from the value of the variable whenever a graphic object is processed by the windows procedure.

At the point in time when the value of the variable becomes 0, all graphic objects to be displayed on the screen have been completely processed. At that time, the determination unit 220 displays the graphic object stored in the buffer 240 on a screen through the display unit 230.

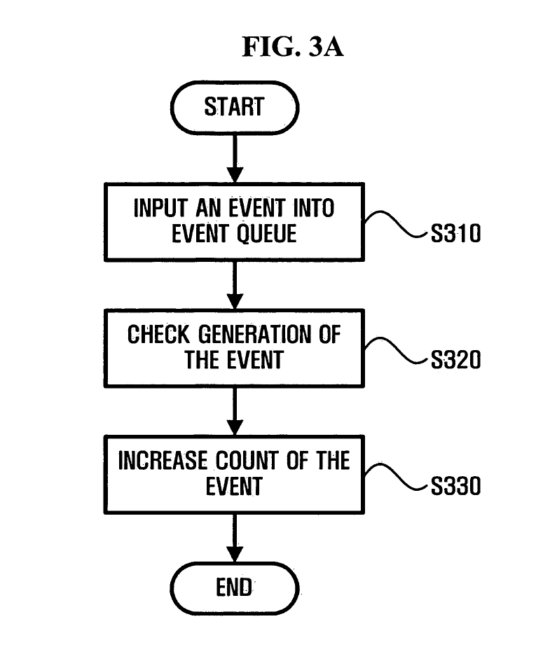

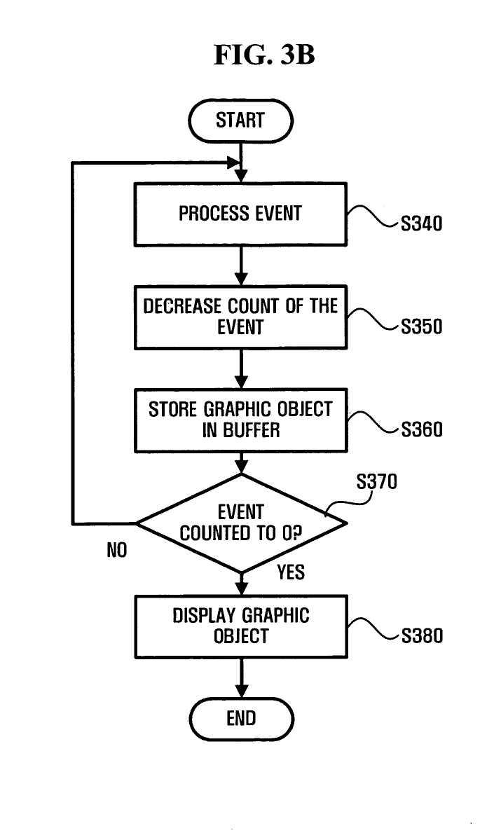

FIG. 3A and FIG. 3B are flowcharts showing the displaying of graphic objects concurrently, according to an exemplary embodiment of the present invention.

When an event is generated to display a graphic object, for example, when an application is initialized, a special area of the main window has to be re-drawn or an InvalidateRect function is called, and the windows operating system inputs a generated message into a message queue of the application (S310), and the event check unit 210 checks whether the event to display the graphic object has been generated by using the above operation (S320).

The determination unit 220 adds 1 to the value of the variable and then stores the result (S330).

The graphic object is processed according to a message transmitted to the windows procedure (S340). Thereafter, the determination unit 220 subtracts 1 from the value of the variable and then stores the result (S350).

The determination unit 220 stores the processed graphic object in the buffer 240 (S360).

The checking of whether the event has been generated, and the increasing and decreasing of the variable according to the processing of the graphic object, are determined by the number of graphic objects in an application, and the determination unit 220 checks whether the value of the variable has become 0 (S370). Since the point in time that the value of the variable becomes 0 is when all the graphic objects which have to be displayed on a screen have been completely processed, the determination unit 220 allows the display unit 230 to display the graphic object stored in the buffer 240 on a screen (S380).

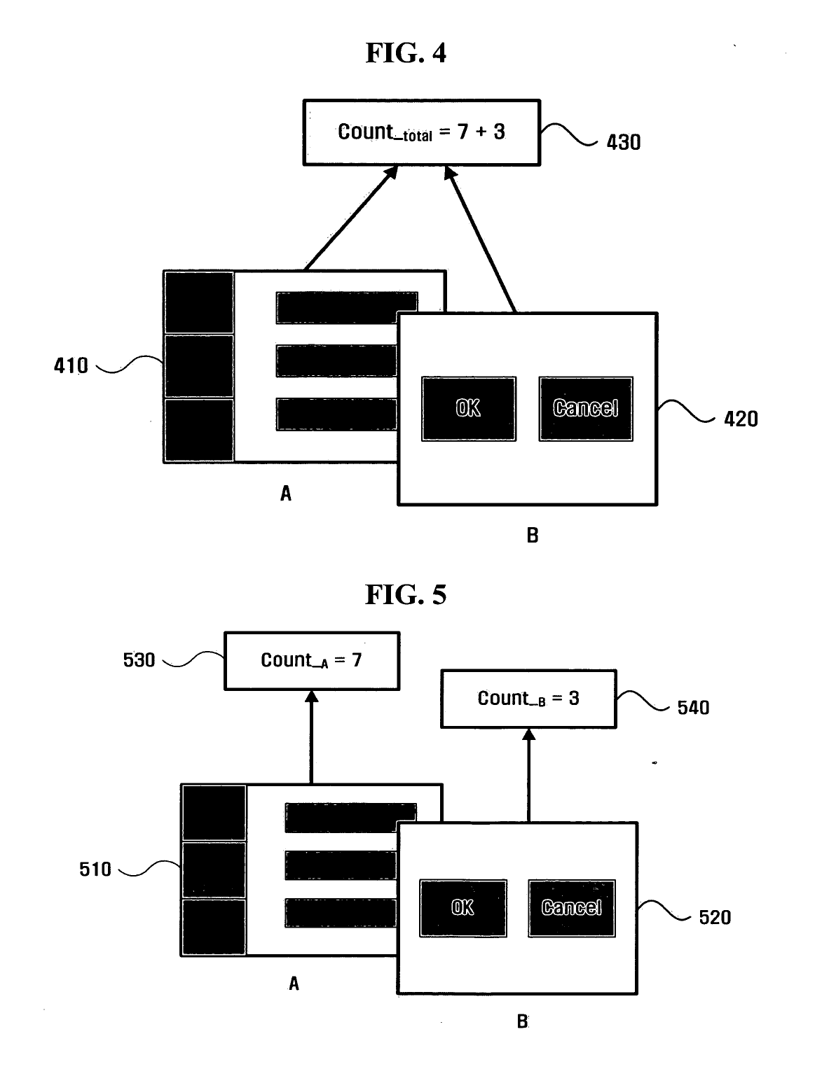

FIG. 4 is a view showing the displaying of a plurality of windows using one variable, according to an exemplary embodiment of the present invention.

A plurality of windows may be displayed through one application or a plurality of applications. In FIG. 4, a plurality of windows 410 and 420 are displayed by using one variable 430.

A window A 410 consists of seven graphic objects: one main window and six buttons. A window B 420 consists of three graphic objects: one main window and two buttons.

The variable is set up as a global variable (Count_{—total}).

If an event to display graphic objects for the window A 410, a child window of the window A 410, the window B 420 or a child window of the window B 420 is generated, the event check unit 210 checks whether the event to display the concerned graphic object has been generated.

If generation of the event is checked by the event check unit 210, the Count_{—total} 430 is increased by 1, and if the graphic object is processed by the windows procedure, the Count_{—total} 430 is decreased by 1.

The value of the global variable Count_{—total} 430 is counted regardless of the window, and the window A 410, the child window of the window A 410, the window B 420, and the child window of the window B 420 are not displayed on a screen, but are instead stored in the buffer 240, before the result has become 0. The window A 410, the child window of the window A 410, the window B 420, and the child window of the window B 420 are displayed concurrently at the point in time when the value of the global variable Count_{—total} 430 becomes 0.

FIG. 5 is a view showing the displaying of a plurality of windows by using a plurality of variables, according to an exemplary embodiment of the present invention.

A plurality of windows may be displayed by one application or a plurality of applications. In FIG. 5, a plurality of windows 510 and 520 are displayed by using a plurality of variables 530 and 540.

Window A 510 consists of seven graphic objects: one main window and six buttons. Window B 520 consists of three graphic objects: one main window and two buttons.

The variables are set up as local variables. A local variable Count_{—A} 530 is set up in window A 510, and a local variable Count_{—B} 540 is set up in window B 520.

If an event to display a graphic object in the window A 510, a child window of the window A 510, the window B 520 or a child window of the window B 520 is generated, the event check unit 210 checks whether the event to display the graphic object has been generated.

The determination unit 220 determines which window the event refers to. If the event refers to the window A 510 or the child window of the window A 510, the local variable Count_{—A} 530 is increased by 1. If the checked event refers to the window B 520 or the child window of the window B 520, the local variable Count_{—B} 540 is increased by 1. Conversely, if a graphic object is processed by the windows procedure, the local variable Count_{—A} 530 or the local variable Count_{—B} 540 is decreased by 1.

As described above, the value of the local variable Count_{—A} 530 or the local variable Count_{—B} 540 is counted according to a window, and whether to display a graphic object of the window is determined as a result of each count. In other words, if the value of the local variable Count_{—A} 530 of the window A 510 is not 0, the window A 510 is stored in the buffer 240 and not displayed, and the window B 520 is displayed on a screen through the display unit 230 if the value of the local variable Count_{—B} 540 is 0.

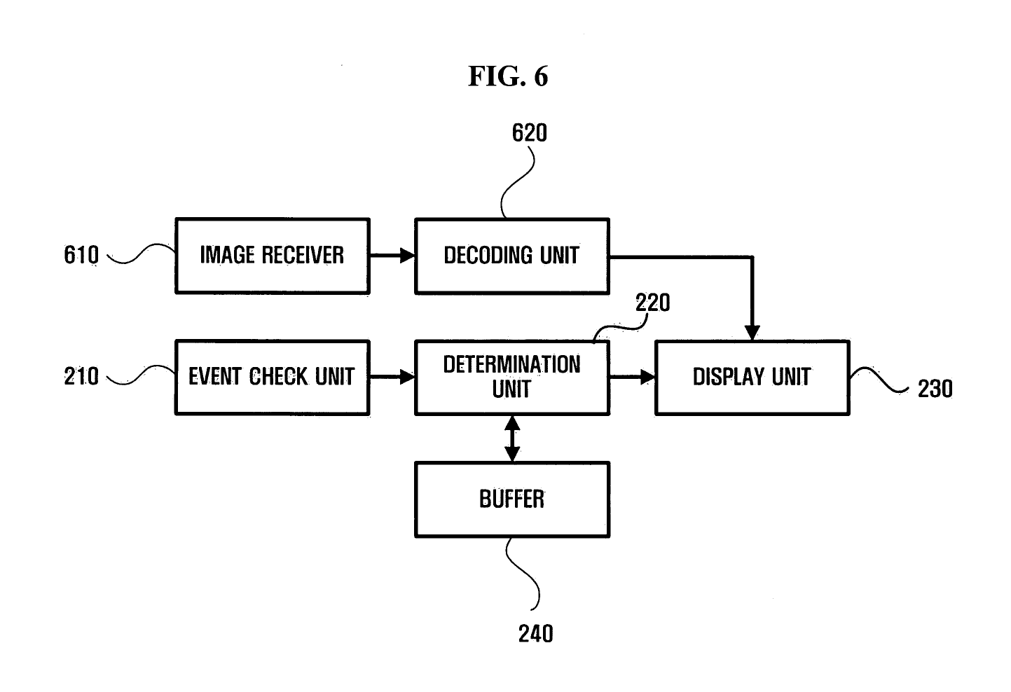

FIG. 6 is a block diagram showing a digital TV to display graphic objects concurrently thereon, according to an exemplary embodiment of the present invention.

Since a general desktop or laptop computer is relatively superior in performance, a transition of a window is seldom generated, but because home appliances are inferior in performance, a transition of a window may be frequent.

A device to display graphic objects concurrently is attached to the digital TV, as illustrated in FIG. 6.

The digital TV basically includes an image receiver 610 and a decoding unit 620, in addition to the device to display graphic objects concurrently.

The image receiver 610 receives a compressed digital image in a wired or wireless manner, and it may include a buffer to smooth the flow of the image being received. The compressed digital image received by the image receiver 610 is transmitted to the decoding unit 620.

The decoding unit 620 decompresses the compressed digital image transmitted from the image receiver 610 and recovers the original image thereof. And the decoding unit 620 may additionally process the digital image. The original image recovered by the decoding unit 620 is displayed on a screen through the display unit 230.

As described above, the digital TV is not just used as a TV receiver. For example, in addition to displaying a variety of digital broadcasting services, the digital TV in a home network is also used to control devices constituting the home network. Here, a graphic user interface is used to help a user perform the above operation, but a transition of a window may be generated in a digital TV whose computing efficiency is relatively inferior.

The display unit 230 may display graphic objects while displaying broadcast content. An event whose generation has been checked by the event check unit 210 is transmitted to the determination unit 220.

Since the determination unit 220 checks the number of times the event, whose generation has been checked, has been processed, and the number of times the graphic object has been processed, and sets a variable, the proper graphic object is stored in the buffer 240 according to the value of the variable, or the graphic object stored in the buffer 240 is displayed on a screen through the display unit 230.

As described above, according to exemplary embodiments of an apparatus and a method for displaying graphic objects concurrently, the present invention may have the following effect.

That is, when a plurality of graphic objects are displayed on a screen by an event handler, a plurality of graphic objects may be concurrently displayed, even in a system having a lower performance, since all the graphic objects are displayed after capturing the point in time when an event is transmitted to the last graphic object.

While exemplary embodiments of the present invention have been described above in detail, it will be understood by those skilled in the art that various changes in form and details may be made therein without departing from the spirit and scope of the invention as defined by the appended claims. Therefore, the exemplary embodiments should be considered in a descriptive sense only and not for purposes of limitation.

What is claimed is:

1. An apparatus for displaying graphic objects concurrently, the apparatus comprising:
an event check unit which checks whether an event to display a graphic object has been generated;
a buffer which stores the graphic object processed according to the event;
a determination unit which determines whether the graphic object should be displayed based on a number of times the event, whose generation has been checked by the event check unit, and the graphic object have been processed; and
a display unit which displays the graphic object stored in the buffer if the determination unit determines the graphic object should be displayed.

2. The apparatus of claim 1, wherein the graphic object refers to at least one of a window, a frame, a dialogue, a button, a check box, a radio box, a list, a scroll bar and a menu bar.

3. The apparatus of claim 1, wherein the determination unit determines a value based on the number of times the event, whose generation has been checked by the event check unit, and the graphic object have been processed, by using a variable, and
wherein the determination unit determines whether to display the graphic object based on the value.

4. The apparatus of claim 3, wherein the variable is stored in a first area of a memory which is different from a second area of the memory where the graphic object is stored.

5. The apparatus of claim 3 further comprising, if the graphic object is one a plurality of graphic objects embodied through a plurality of applications, the determination unit determines the value based on the number of times the event, whose generation has been checked by the event check unit, and the graphic object have been processed, by setting up a global variable shared by the applications.

6. The apparatus of claim 3 further comprising, if the graphic object is one a plurality of graphic objects embodied through a plurality of applications, the determination unit determines a plurality of values, each value based on a number of times an event, whose generation is checked by the event check unit, and a graphic object corresponding to the event is processed for one of the applications, by setting up a local variable for each of the applications.

7. A method for displaying graphic objects concurrently, the method comprising:
checking whether an event to display a graphic object has been generated;
storing the graphic object processed according to the event in a memory;
determining whether the graphic object should be displayed based on a number of times the event, whose generation has been checked, and the graphic object have been processed; and
displaying the graphic object stored in the memory if it is determined that the graphic object should be displayed.

8. The method of claim 7, wherein the graphic object refers to at least one of a window, a frame, a dialogue, a button, a check box, a radio box, a list, a scroll bar and a menu bar.

9. The method of claim 7, wherein determining whether the graphic object should be displayed comprises determining a value based on the number of times the event, whose generation has been checked, and the graphic object have been processed, by using a variable.

10. The method of claim 9, wherein the variable is stored in a first area of the memory different from a second area of the memory where the graphic object is stored.

11. The method of claim 9, further comprising, if the graphic object is one of a plurality of graphic objects embodied through a plurality of applications, the determination unit determines the value based on the number of times the event, whose generation has been checked, and the graphic object have been processed, by setting up a global variable shared by the applications.

12. The method of claim 9, further comprising, if the graphic object is one a plurality of graphic objects embodied through a plurality of applications, the determination unit determines a plurality of values, each value based on a number of times an event, whose generation is checked by the event check unit, and a graphic object corresponding to the event is processed for one of the applications, by setting up a local variable for each of the applications.
